(19) United States
(12) Patent Application Publication
(10) Pub. No.: US 2026/0192533 A1
(43) Pub. Date: Jul. 9, 2026

(54) ACCESSORY SET OF TIRE REPAIRING DEVICE

(71) Applicant: UNIK WORLD INDUSTRIAL CO., LTD., Tainan City (TW)

(72) Inventors: Wen San Chou, Tainan City (TW); Cheng Hsien Chou, Tainan City (TW)

(73) Assignee: UNIK WORLD INDUSTRIAL CO., LTD., Tainan City (TW)

(21) Appl. No.: 19/046,442

(22) Filed: Feb. 5, 2025

(30) Foreign Application Priority Data
Jan. 8, 2025 (TW) 114200308

(51) Int. Cl. B29C 73/02; B60S 5/00

(52) U.S. Cl. CPC B29C 73/025; B60S 5/00

(57) ABSTRACT

Provided is an accessory set of a tire repairing device, which includes an inflating hose and a bracket-type cap body. The bracket-type cap body has a screwing cap, a pipeline portion, and a bracket. The pipeline portion is connected between the screwing cap and the bracket. The pipeline portion is communicated with an internal space of the screwing cap to be communicated with a glue can when the screwing cap is fastened to the glue can. The pipeline portion has an air inlet to be connected to an air compressor. The pipeline portion has an air outlet to be connected to an air nozzle of a tire through the inflating hose. The bracket-type cap body is adapted to hold on a ground or a platform with the bracket to support the inverted glue can.

### CROSS-REFERENCE TO RELATED APPLICATION

This application claims the priority benefit of Taiwan application serial no. 114200308, filed on January 8, 2025. The entirety of the foregoing patent application is hereby incorporated by reference herein and made a part of this specification.

### BACKGROUND

### Technical Field

The disclosure relates to an accessory set of a tire repairing device.

### Related Art

In a current tire repairing device, for ease of the user to execute an operation of applying glue, a glue can which serves as a glue-holding container is often combined with a bottle cap, and an inflating hose is wound around the glue can and the bottle cap, which is provided as a finished product.

Although this approach is convenient, other problems may be generated. For example, during the process of storing or delivering the tire repairing device, the inflating hose and a connecting port of which to the glue can may be easily damaged due to collisions. At the same time, during the process of delivering a product, the connection between the glue can and the bottle cap may be weakened or even loosened due to temperature changes and vibrations, causing the condition of glue leakage.

### SUMMARY

The disclosure provides an accessory set of a tire repairing device, which separates and stores a bracket-type cap body and a glue can, so that the two may be combined when in use, which facilitates the storage and logistics in a previous stage. At the same time, a receiving box is provided for storing the bracket-type cap body and an inflating hose, thereby forming an accessorized peripheral product.

The accessory set of the tire repairing device of the disclosure includes an inflating hose and a bracket-type cap body. The bracket-type cap body has a screwing cap, a pipeline portion, and a bracket. The pipeline portion is connected between the screwing cap and the bracket. The pipeline portion is communicated with an internal space of the screwing cap to be communicated with a glue can when the screwing cap is fastened to the glue can. The pipeline portion has an air inlet to be connected to an air compressor. The pipeline portion has an air outlet to be connected to an air nozzle of a tire through the inflating hose. The bracket-type cap body is adapted to hold on a ground or a platform with the bracket to support the inverted glue can.

The accessory set of the tire repairing device of the disclosure includes an inflating hose, a bracket-type cap body, and a receiving box. The bracket-type cap body is connected to the inflating hose. The bracket-type cap body has multiple supporting protrusions annularly disposed at intervals. The receiving box has multiple stop protrusions annularly disposed at intervals, so that when the bracket-type cap body and the inflating hose are stored in the receiving box, the inflating hose is wound and accommodated between the bracket-type cap body and the receiving box, and the stop protrusions correspondingly abut against the supporting protrusions to block the bracket-type cap body and the inflating hose from falling out of the receiving box.

In an embodiment of the disclosure, the foregoing stop protrusions form multiple notches on the receiving box. The bracket-type cap body in the receiving box is adapted to move along an arc-shaped path to allow the supporting protrusions to move to the stop protrusions, or to allow the supporting protrusions to move to the notches. When the supporting protrusions are moved to the notches, the bracket-type cap body is adapted to move out of or move into the receiving box.

In an embodiment of the disclosure, a bottom of the foregoing receiving box further includes a fixing portion. One end of the inflating hose is adapted to be positioned at the fixing portion and then stored in the receiving box in a winding manner.

In an embodiment of the disclosure, a bottom of the foregoing receiving box further includes a positioning protrusion. The bracket-type cap body has a screwing cap, so that when the bracket-type cap body is stored in the receiving box, the screwing cap is sleeved on the positioning protrusion.

In an embodiment of the disclosure, the foregoing bracket-type cap body has a screwing cap, a pipeline portion, and a bracket. The pipeline portion is connected between the screwing cap and the bracket. The pipeline portion is communicated with an internal space of the screwing cap to be communicated with a glue can when the screwing cap is fastened to the glue can. The pipeline portion has an air inlet to be connected to an air compressor. The pipeline portion has an air outlet to be connected to an air nozzle of a tire through the inflating hose. The bracket has the supporting protrusions. The bracket-type cap body is adapted to hold on a ground or a platform with the bracket to support the inverted glue can.

In an embodiment of the disclosure, when the bracket-type cap body is assembled to the glue can, the pipeline portion and the screwing cap form a necking structure relative to the bracket and the glue can. The inflating hose is adapted to be wound around the necking structure.

In an embodiment of the disclosure, the foregoing screwing cap has a blade-shaped protruding portion located in the internal space. The blade-shaped protruding portion breaks a sealing film of the glue can as the screwing cap is fastened to the glue can to allow the glue can to be communicated with the internal space of the screwing cap.

In an embodiment of the disclosure, the foregoing bracket is presented as a floral shape and has the foregoing supporting protrusions to hold on the ground or the platform.

In an embodiment of the disclosure, the foregoing bracket has an arc-shaped concave surface facing away from the pipeline portion, and the foregoing supporting protrusions are annularly disposed on the arc-shaped concave surface.

Based on the above, the accessory set of the tire repairing device includes the inflating hose and the bracket-type cap body. The bracket-type cap body has the screwing cap, the pipeline portion, and the bracket. The pipeline portion is connected between the screwing cap and the bracket. The bracket-type cap body may not only be fastened to a glue can which holds glue inside, but may also be connected an air compressor and a tire through the pipeline portion, which facilitates the air compressor to inflate air in the tire through the pipeline portion, and may also drive the glue in the glue can to repair the tire. For smooth operation, the bracket-type cap body stands on the ground or the platform with the bracket, and serves as a support when the glue can is inverted. The accessory set of the tire repairing device further includes the receiving box for storing the bracket-type cap body and the inflating hose. The multiple supporting protrusions of the bracket abut against the stop protrusions of the receiving box to provide protection for the bracket-type cap body and the inflating hose in the receiving box and prevent from falling out.

### BRIEF DESCRIPTION OF THE DRAWINGS

FIG. 1 is a schematic view of an accessory set of a tire repairing device according to an embodiment of the disclosure.

FIG. 2 is an exploded schematic view of the accessory set of the tire repairing device in FIG. 1.

FIG. 3 is a schematic view of a combination of an accessory set of a tire repairing device and a glue can.

FIG. 4 is a schematic view of an accessory set of a tire repairing device during operation.

FIG. 5 is a partial cross-sectional view of the accessory set of the tire repairing device in FIG. 4.

FIG. 6 is a schematic view of an accessory set of a tire repairing device according to another embodiment of the disclosure.

FIG. 7 is a cross-sectional view of the accessory set of the tire repairing device in FIG. 6.

FIG. 8 and FIG. 9 are respectively schematic views of a detachment of components of an accessory set of a tire repairing device.

FIG. 10 is a schematic view of an assembly of components of an accessory set of a tire repairing device.

### DESCRIPTION OF THE EMBODIMENTS

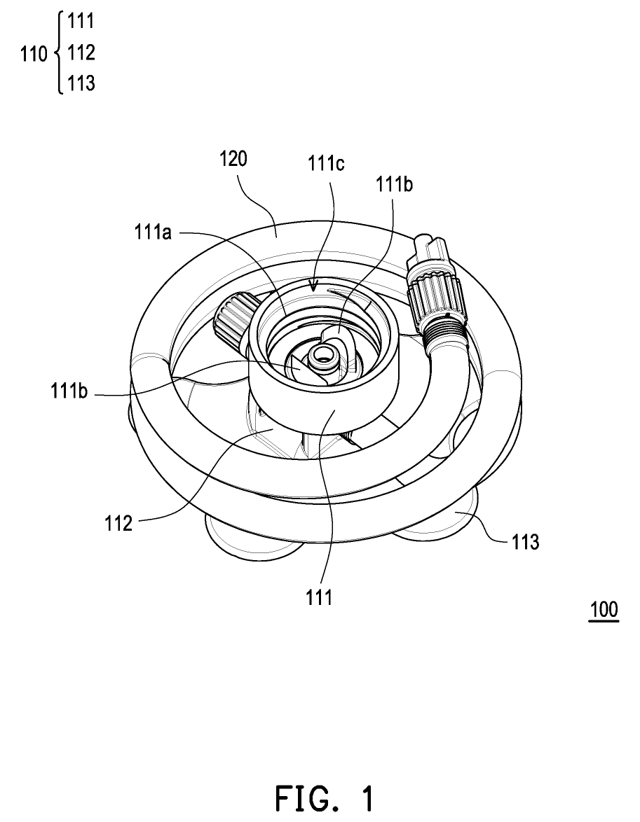

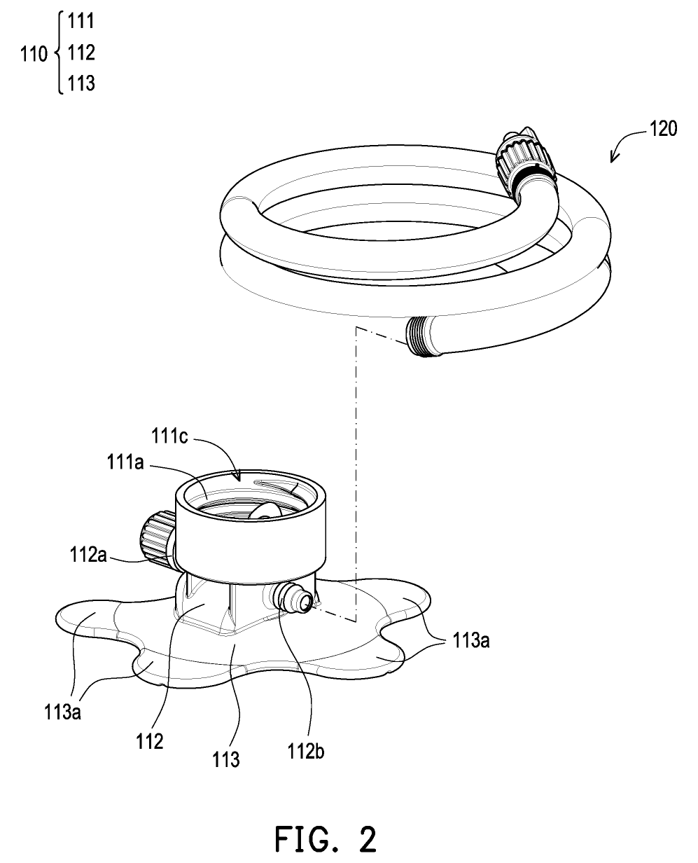

FIG. 1 is a schematic view of an accessory set of a tire repairing device according to an embodiment of the disclosure. FIG. 2 is an exploded schematic view of the accessory set of the tire repairing device in FIG. 1. Please refer to FIG. 1 and FIG. 2 at the same time. In the embodiment, an accessory set of a tire repairing device 100 includes an inflating hose 120 and a bracket-type cap body 110. The bracket-type cap body 110 has a screwing cap 111, a pipeline portion 112, and a bracket 113. The pipeline portion 112 is connected between the screwing cap 111 and the bracket 113. The pipeline portion 112 is communicated with an internal space 111c of the screwing cap 111.

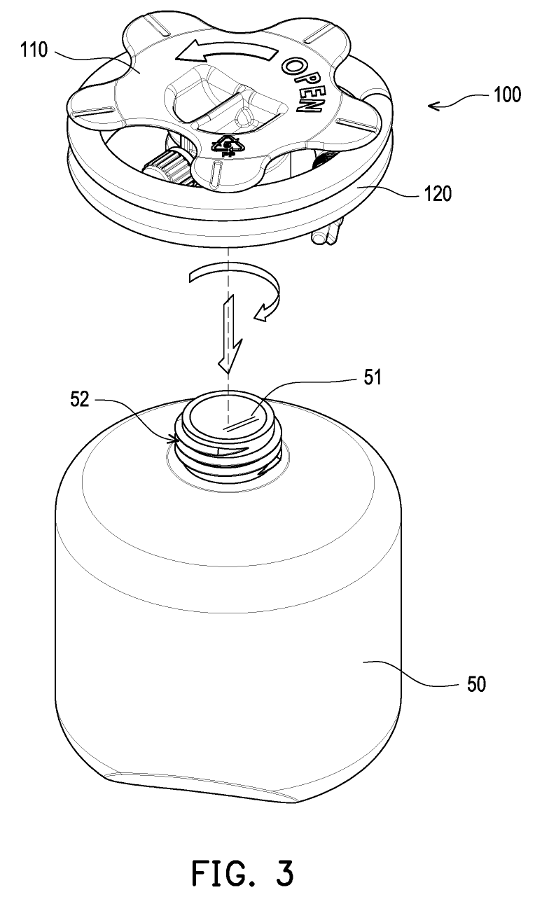

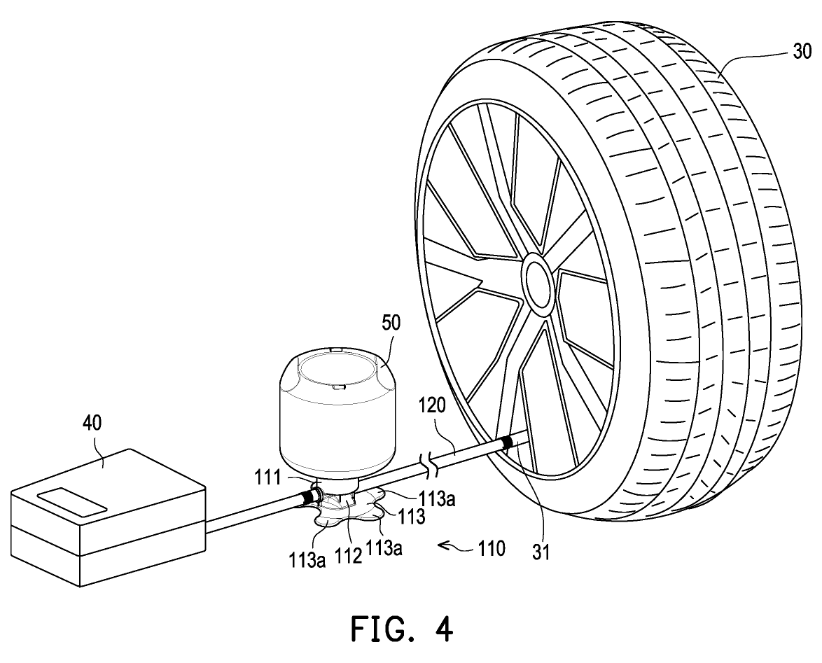

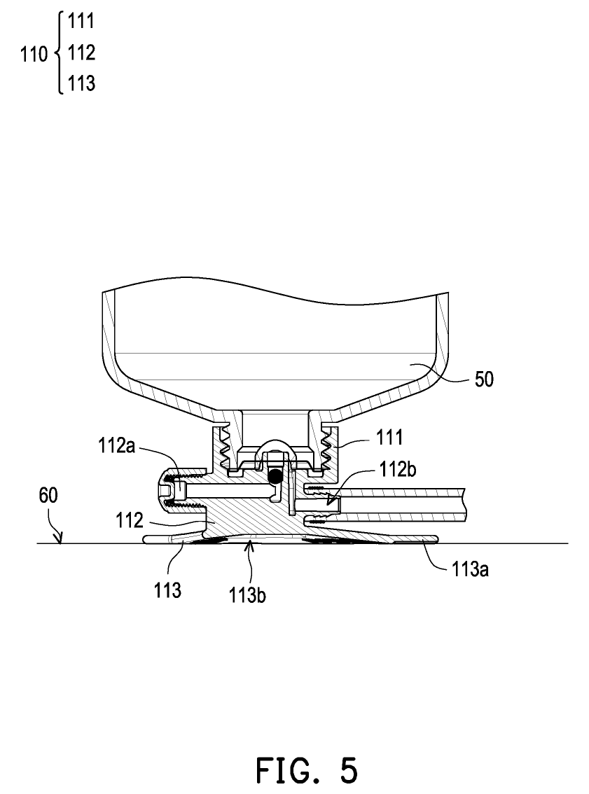

FIG. 3 is a schematic view of a combination of an accessory set of a tire repairing device and a glue can. FIG. 4 is a schematic view of an accessory set of a tire repairing device during operation. FIG. 5 is a partial cross-sectional view of the accessory set of the tire repairing device in FIG. 4. Please refer to FIG. 1 and FIG. 2 first. The accessory set of the tire repairing device 100 includes the inflating hose 120 and the bracket-type cap body 110. The bracket-type cap body 110 has the screwing cap 111, the pipeline portion 112, and the bracket 113. The pipeline portion 112 is connected between the screwing cap 111 and the bracket 113.

The inflating hose 120 of the embodiment is adapted to be wound around the bracket-type cap body 110 to form a storage state when not in use, as shown in FIG. 1. Conversely, when the accessory set of the tire repairing device 100 is in use, the screwing cap 111 is fastened to the glue can 50 first as shown in FIG. 3 (please refer to FIG. 1 at the same time to facilitate the identification of the features of components),which is then connected between an air compressor 40 and a tire 30, as shown in FIG. 4, to perform an operation of inflating air or applying glue on the tire 30. Since the screwing cap 111 has a blade-shaped protruding portion 111b located in the internal space 111c, during the fastening process in FIG. 3, an internal thread 111a of the screwing cap 111 fits an external thread 52 at a bottleneck of the glue can 50 to be fastened. At the same time, the blade-shaped protruding portion 111b may break a sealing film 51 of the glue can 50 as the screwing cap 111 is fastened (rotated) to allow the glue can 50 to be communicated with the internal space 111c of the screwing cap 111, and consequently to allow (part of the pipeline of) the pipeline portion 112 and the glue can 50 to be in communication with each other.

Moreover, after the assembly of the bracket-type cap body 110 of the accessory set of the tire repairing device 100 and the glue can 50 is completed, the pipeline portion 112 and the screwing cap 111 form a necking structure relative to the bracket 113 and the glue can 50 to allow the inflating hose 120 to be adapted to be wound around the necking structure.

FIG. 5 is a partial cross-sectional view of the accessory set of the tire repairing device in FIG. 4. Please refer to FIG. 4 and FIG. 5 at the same time. Following the foregoing assembly, the glue can 50 and the accessory set of the tire repairing device 100 are inverted as shown in FIG. 4. Since the bracket 113 is presented as a floral shape and have multiple supporting protrusions 113a, the bracket 113 is allowed to be held on a ground or a platform 60 to support the inverted glue can 50 through the supporting protrusions 113a abutting against the ground or the platform 60. Furthermore, the bracket 113 has an arc-shaped concave surface 113b facing away from the pipeline portion 112. The arc-shaped concave surface 113b facilitates the supporting effect of the bracket 113 abutting against the ground or the platform 60 with the multiple supporting protrusions 113a, which may distribute the force and improve stability during standing. In this way, the accessory set of the tire repairing device 100 may stably carry the inverted glue can 50. At the same time, the pipeline portion 112 of the embodiment has an air inlet 112a to be connected to the air compressor 40. The pipeline portion 112 further has an air outlet 112b to be connected to an air nozzle 31 of the tire 30 through the inflating hose 120. This completes the operation of inflating air or applying glue as shown in FIG. 4.

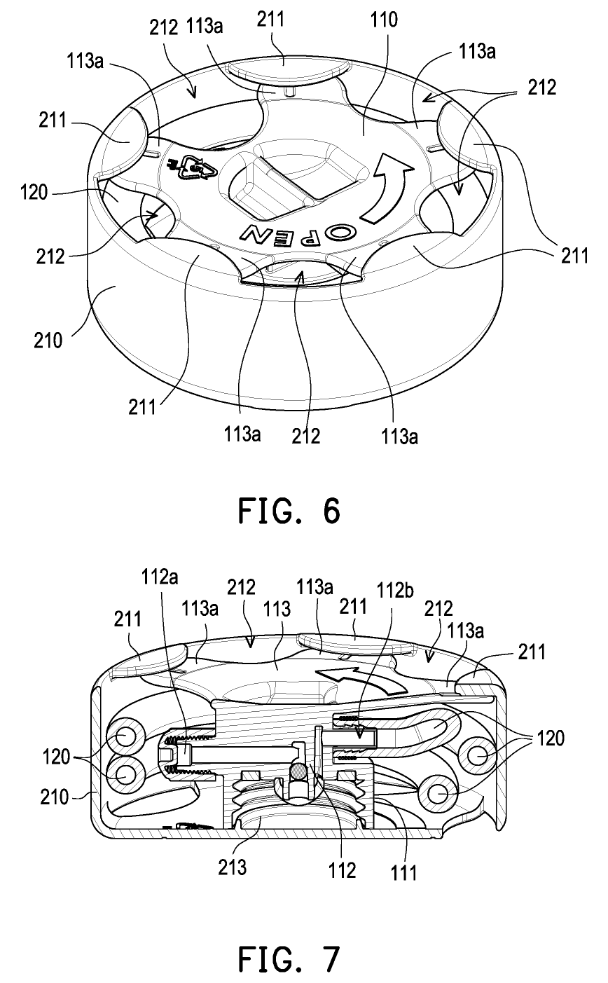

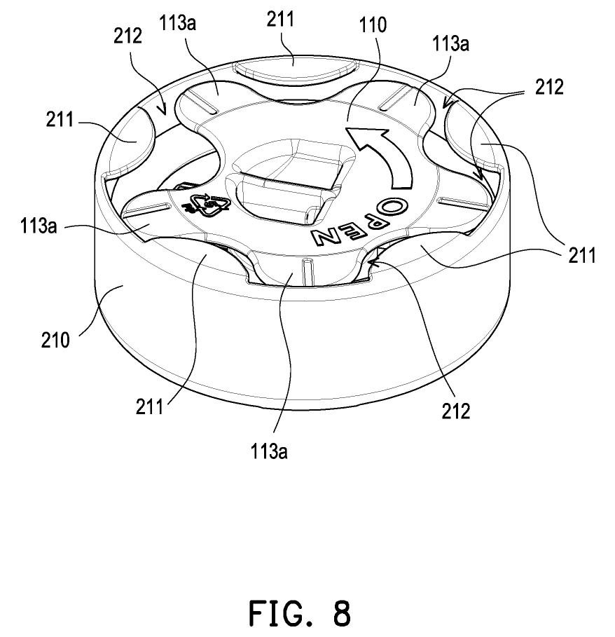

FIG. 6 is a schematic view of an accessory set of a tire repairing device according to another embodiment of the disclosure. FIG. 7 is a cross-sectional view of the accessory set of the tire repairing device in FIG. 6. Please refer to FIG. 6 and FIG. 7 at the same time. An accessory set of a tire repairing device 200 disclosed in the embodiment includes the inflating hose 120, the bracket-type cap body 110, and a receiving box 210. The purpose of another form of implementation is to allow the inflating hose 120 and the bracket-type cap body 110 to be easily stored and carried, and to serve as a type of the accessory set of the tire repairing device to facilitate productization. Here, the bracket-type cap body 110 and the inflating hose 120 are as described in the foregoing embodiment, and will not be repeated. The following will only further elaborate on how to be convenient in storage and carrying.

In the embodiment, the receiving box 210 has multiple stop protrusions 211 annularly disposed at intervals. The stop protrusions 211 are located at the entrance of a box body. The supporting protrusions 113a of the bracket-type cap body 110 are also annularly disposed at intervals and correspond to the stop protrusions 211. Therefore, when the bracket-type cap body 110 and the inflating hose 120 are stored in the receiving box 210, the inflating hose 120 is wound and accommodated between the bracket-type cap body 110 and the receiving box 210. The stop protrusions 211 correspondingly abut against the supporting protrusions 113a of the bracket 113 to block the bracket-type cap body 110 and the inflating hose 120 from falling out of the receiving box 210.

As shown in FIG. 7, the bottom of the receiving box 210 further has a positioning protrusion 213, so that when the bracket-type cap body 110 is stored in the receiving box 210, the screwing cap 111 of the bracket-type cap body 110 may be directly sleeved on the positioning protrusion 213. In addition to serving as a guide to facilitate user positioning during the storage process, the positioning protrusion 213 which positions the screwing cap 111 may also facilitate the bracket-type cap body 110 and the inflating hose 120 to be integrally fixed in the receiving box 210 without wobbling during the storage state, especially when the supporting protrusions 113a and the stop protrusions 211 correspondingly abut against each other.

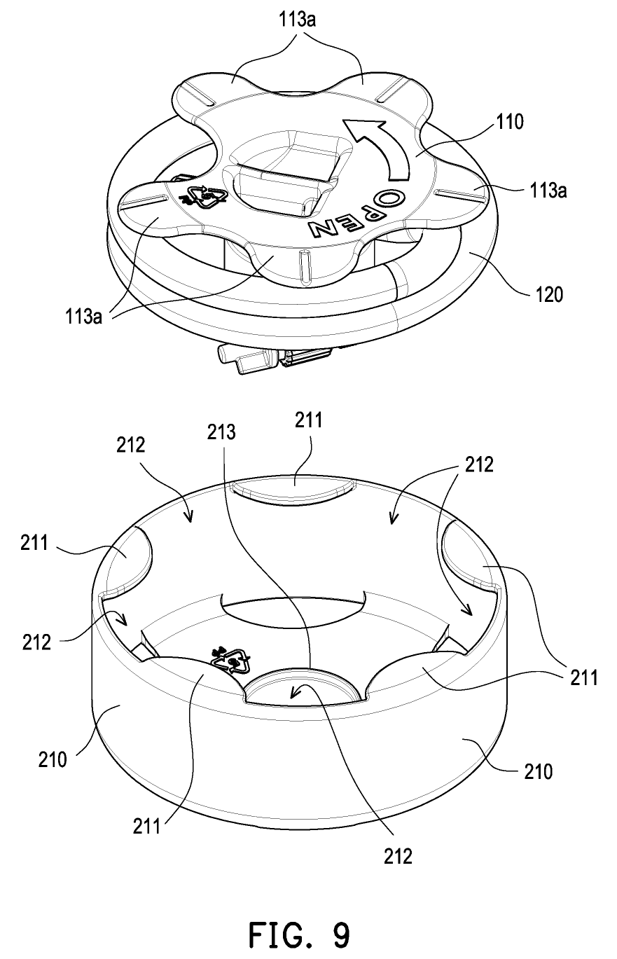

FIG. 8 and FIG. 9 are respectively schematic views of a detachment of components of an accessory set of a tire repairing device. Please refer to FIG. 6, FIG. 8, and FIG. 9 at the same time. For the receiving box 210, since the stop protrusions 211 are annularly disposed at intervals, multiple notches 212 may also be formed at the entrance of the receiving box 210, and arranged at intervals with the foregoing stop protrusions 211 in sequence. Therefore, during the process from FIG. 6 to FIG. 8, the bracket-type cap body 110 in the receiving box 210 is moved along an arc-shaped path, as shown by the arrow on the bracket-type cap body 110, to allow the supporting protrusions 113a to move from the stop protrusions 211 to the notches 212. Subsequently, as shown in FIG. 9, the bracket-type cap body 110 (and the inflating hose 120 wound therearound) may be smoothly moved out of the receiving box 210. Conversely, after the bracket-type cap body 110 and the inflating hose 120 allow the supporting protrusions 113a to pass through the notches 212, and to be placed into the receiving box 210, which is the process from FIG. 9 to FIG. 8, the bracket-type cap body 110 may be rotated to allow the supporting protrusions 113a to move from the notches 212 to the stop protrusions 211 and abut against each other, thus smoothly allowing the bracket-type cap body 110 and the inflating hose 120 to be stored and fixed in the receiving box 210.

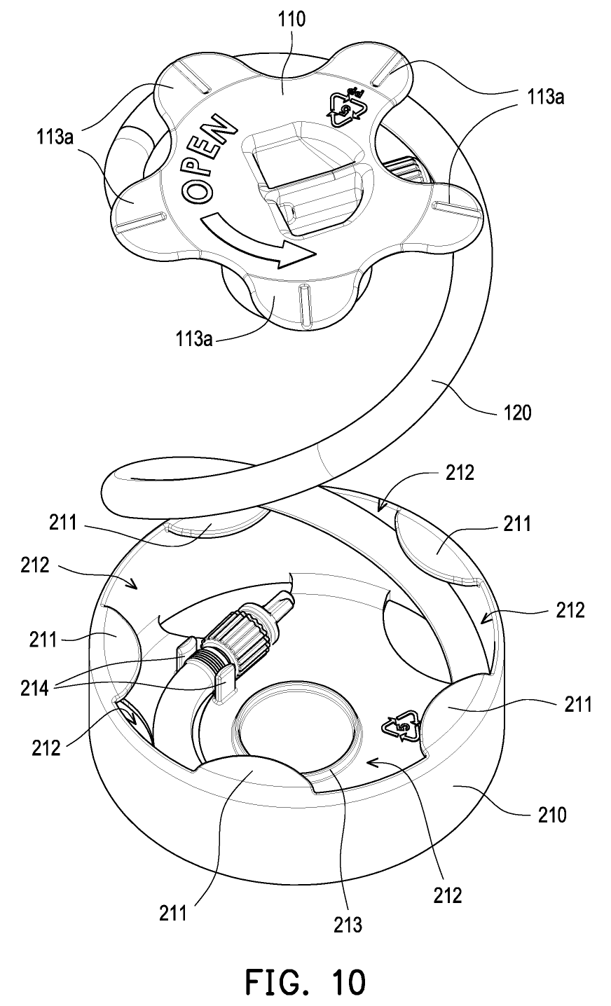

FIG. 10 is a schematic view of an assembly of components of an accessory set of a tire repairing device. Please refer to FIG. 10. In the process of placing the bracket-type cap body 110 and the inflating hose 120 wound therearound into the receiving box 210 as previously mentioned, one end of the inflating hose 120 may be further positioned at a fixing portion 214 disposed at the bottom of the receiving box 210, and then the inflating hose 120 is stored in a winding manner until the bracket-type cap body 110 is stored in the receiving box 210. This approach allows one end of the inflating hose 120 to be fixed, which helps improving the user's convenience in rolling up the inflating hose 120.

In summary, in the foregoing embodiment of the disclosure, the accessory set of the tire repairing device includes the inflating hose and the bracket-type cap body. The bracket-type cap body has the screwing cap, the pipeline portion, and the bracket. The pipeline portion is connected between the screwing cap and the bracket. The bracket-type cap body may not only be fastened to the glue can which holds glue inside, but may also be connected to the air compressor and the tire through the pipeline portion, which facilitates the air compressor to inflate air in the tire through the pipeline portion, and may also drive the glue in the glue can to repair the tire. To ensure smooth operation, the bracket-type cap body stands on the ground or the platform with the bracket thereof, and serves as a support when the glue can is inverted. The accessory set of the tire repairing device further include the receiving box for storing the bracket-type cap body and the inflating hose. The multiple supporting protrusions of the bracket abut against the stop protrusions of the receiving box to provide protection for the bracket-type cap body and the inflating hose in the receiving box and prevent from falling out.

In addition, the inflating hose and the bracket-type cap body may be further combined with the receiving box to be another form of the accessory set of the tire repairing device. The purpose is to allow the inflating hose and bracket-type cap body to be easily stored and carried, and further productized. The receiving box serves to store the inflating hose and the bracket-type cap body, and has the stop protrusions and the notches corresponding to the supporting protrusions. The notches may allow the supporting protrusions to pass through to allow the supporting protrusions and the stop protrusions to be clamped with each other after the bracket is rotated, allowing the bracket-type cap body and the inflating hose to be securely stored in the receiving box without wobbling. At the same time, during the foregoing storage process, one end of the inflating hose may be fixed by the fixing portion at the bottom of the receiving box, which facilitates the user to gradually wind the inflating hose and gradually store in the receiving box until the foregoing bracket-type cap body completes the clamping action with the receiving box.

What is claimed is:

1. An accessory set of a tire repairing device, comprising:
an inflating hose; and
a bracket-type cap body, having a screwing cap, a pipeline portion and a bracket, wherein the pipeline portion is connected between the screwing cap and the bracket, the pipeline portion is communicated with an internal space of the screwing cap to be communicated with a glue can when the screwing cap is fastened to the glue can, the pipeline portion has an air inlet to be connected to an air compressor, the pipeline portion has an air outlet to be connected to an air nozzle of a tire through the inflating hose, wherein the bracket-type cap body is adapted to hold on a ground or a platform with the bracket to support the inverted glue can.

2. The accessory set of the tire repairing device according to claim 1, wherein when the bracket-type cap body is assembled to the glue can, the pipeline portion and the screwing cap form a necking structure relative to the bracket and the glue can, and the inflating hose is adapted to be wound around the necking structure.

3. The accessory set of the tire repairing device according to claim 1, wherein the screwing cap has a blade-shaped protruding portion located in the internal space, and the blade-shaped protruding portion breaks a sealing film of the glue can as the screwing cap is fastened to the glue can to allow the glue can to be communicated with the internal space.

4. The accessory set of the tire repairing device according to claim 1, wherein the bracket is presented as a floral shape and has a plurality of supporting protrusions to abut against the ground or the platform.

5. The accessory set of the tire repairing device according to claim 1, wherein the bracket has an arc-shaped concave surface facing away from the pipeline portion.

6. An accessory set of a tire repairing device, comprising:
an inflating hose;
a bracket-type cap body, connected to the inflating hose, and the bracket-type cap body having a plurality of supporting protrusions annularly disposed at intervals; and
a receiving box, having a plurality of stop protrusions annularly disposed at intervals, so that when the bracket-type cap body and the inflating hose are stored in the receiving box, the inflating hose is wound and accommodated between the bracket-type cap body and the receiving box, and the stop protrusions correspondingly abut against the supporting protrusions to block the bracket-type cap body and the inflating hose from falling out of the receiving box.

7. The accessory set of the tire repairing device according to claim 6, wherein the stop protrusions form a plurality of notches on the receiving box, the bracket-type cap body in the receiving box is adapted to move along an arc-shaped path to allow the supporting protrusions to move to the stop protrusions, or to allow the supporting protrusions to move to the notches, and when the supporting protrusions are moved to the notches, the bracket-type cap body is adapted to move out of or move into the receiving box.

8. The accessory set of the tire repairing device according to claim 6, wherein a bottom of the receiving box further comprises a fixing portion, and one end of the inflating hose is adapted to be positioned at the fixing portion and then stored in the receiving box in a winding manner.

9. The accessory set of the tire repairing device according to claim 6, wherein a bottom of the receiving box further comprises a positioning protrusion, and the bracket-type cap body has a screwing cap, so that when the bracket-type cap body is stored in the receiving box, the screwing cap is sleeved on the positioning protrusion.

10. The accessory set of the tire repairing device according to claim 6, wherein the bracket-type cap body has a screwing cap, a pipeline portion and a bracket, the pipeline portion is connected between the screwing cap and the bracket, the pipeline portion is communicated with an internal space of the screwing cap to be communicated with a glue can when the screwing cap is fastened to the glue can, the pipeline portion has an air inlet to be connected to an air compressor, the pipeline portion has an air outlet to be connected to an air nozzle of a tire through the inflating hose, the bracket has the supporting protrusions, and the bracket-type cap body is adapted to hold on a ground or a platform with the bracket to support the inverted glue can.

11. The accessory set of the tire repairing device according to claim 10, wherein when the bracket-type cap body is assembled to the glue can, the pipeline portion and the screwing cap form a necking structure relative to the bracket and the glue can, and the inflating hose is adapted to be wound around the necking structure.

12. The accessory set of the tire repairing device according to claim 10, wherein the screwing cap has a blade-shaped protruding portion located in the internal space, and the blade-shaped protruding portion breaks a sealing film of the glue can as the screwing cap is fastened to the glue can to allow the glue can to be communicated with the internal space of the screwing cap.

13. The accessory set of the tire repairing device according to claim 10, wherein the bracket is presented as a floral shape and has the supporting protrusions to hold on the ground or the platform.

14. The accessory set of the tire repairing device according to claim 10, wherein the bracket has an arc-shaped concave surface facing away from the pipeline portion, and the supporting protrusions are annularly disposed on the arc-shaped concave surface.
